(19) United States
(12) Patent Application Publication
(10) Pub. No.: US 2026/0048548 A1
(43) Pub. Date: Feb. 19, 2026

(54) FILTER DEVICE FOR ADJUSTING AN ATMOSPHERE WITHIN A MANUFACTURING FACILITY AND MANUFACTURING FACILITY FOR AN ADDITIVE MANUFACTURING PROCESS

(71) Applicant: DMG MORI ADDITIVE GmbH, Bielefeld (DE)

(72) Inventors: Marc TIMMER, Delbrück (DE); Leonhard KOSOG, Werther (DE); Hans-Joerg PUCHER, Schwangau (DE)

(21) Appl. No.: 19/124,234

(22) PCT Filed: Dec. 1, 2023
(86) PCT No.: PCT/EP2023/083941

§ 371 Date: Apr. 24, 2025

(30) Foreign Application Priority Data
Dec. 13, 2022 (DE) 10 2022 133 160.1

(51) Int. Cl. B29C 64/364; B01D 46/00; B01D 46/42; B01D 46/88; B29C 64/153; B29C 64/393; B33Y 30/00; B33Y 40/00; B33Y 50/02

(52) U.S. Cl. CPC B29C 64/364; B01D 46/0005; B01D 46/4209; B01D 46/88; B29C 64/153; B29C 64/393; B33Y 30/00; B33Y 40/00; B33Y 50/02; B01D 2265/06

(57) ABSTRACT

The present invention relates to an automatable manufacturing facility FA based on optical interactions, in particular a manufacturing facility for selective laser melting (SLM), and an integrated filter device FV in which, by selective insertion of device elements, both contamination by different particle residues within the manufacturing facility FA can be avoided and a manufacturing atmosphere defined by a homogeneous process gas flow can be formed. Furthermore, the present invention relates to a manufacturing system for automated manufacturing of workpieces by means of irradiation of a material to be processed, which, with the aid of controlled adaptations of the process gas to be introduced into the manufacturing facility FA to the properties of the filter device FV, enables the previously described generation of the manufacturing atmosphere, in particular independently of the manufacturing materials used.

The present invention relates to an automatable manufacturing facility based on optical interactions, in particular a manufacturing facility for selective laser melting (SLM), and an integrated filter device in which, by selective insertion of device elements, both contamination by different particle residues within the manufacturing facility can be avoided and a manufacturing atmosphere defined by a homogeneous process gas flow can be formed. Furthermore, the present invention relates to a manufacturing system for automated manufacturing of workpieces by means of irradiation of a material to be processed, which, with the aid of controlled adaptations of the process gas to be introduced into the manufacturing facility to the properties of the filter device, enables the previously described generation of the manufacturing atmosphere, in particular independently of the manufacturing materials used.

### BACKGROUND OF THE INVENTION

Due to increasingly complex working processes and the resulting requirement of current manufacturing facilities to be able to manufacture as precisely as possible, in an automated manner and over a large area, the production and processing of workpieces on the basis of optical interaction processes has become established as an effective and important working basis.

Generic manufacturing facilities known from the state of the art and based on optical interaction, such as laser-induced manufacturing facilities and/or manufacturing facilities based on additive manufacturing steps, such as selective laser melting, usually comprise one or more high-intensity light sources, which are coupled to a plurality of finely adjusted optical elements (lenses, mirrors, filters, etc.), which can be controlled in an automated manner via a computer system, and thus make it possible to act plastically on a desired workpiece or a desired material by generating a condensed light beam focused on a specific manufacturing point. By way of example, a manufacturing facility according to the selective laser melting method has at least one laser light source, which, by means of software-supported optics, can focus a bundled laser beam onto pulverulent layers of materials to be processed and thus, by means of local fusions that can be connected to one another layer by layer, can generate an extremely effective, three-dimensional manufacturing process.

Despite continuous further development of such manufacturing facilities, however, the problem still occurs in most of such systems that, due to particle residues falling during the manufacturing process, such as rising spray particles, condensates or soot, the components required for passing on the optical processing beam can be contaminated or even damaged, as a result of which a reduction in the exposure precision and consequently a reduction in the quality of the workpiece to be produced occurs in the case of continuous manufacturing processes. In this respect, manufacturing facilities according to the state of the art provide, for example, for introducing a gas stream into the process chamber of the manufacturing facility to be used, such that any interfering process by-products can already be effectively discharged during individual manufacturing steps.

Regardless of the above-mentioned advantages, however, the use of simple gas inflows within a manufacturing facility has always also been provided with a number of disadvantages. Thus, for example, due to the turbulence-affected properties of the inflowed gas flow, the problem usually occurs that portions of the particles to be separated out can also pass into the feed circuit of the respective gas, as a result of which, for example in the case of provided material changes, complex cleaning processes are required in order to prevent later contamination by accumulated material residues. Furthermore, the introduction mechanisms, such as valves or inlet openings, usually only locally connected to the working region of the manufacturing facility, only bring about an inhomogeneous distribution of the gas flow to be used, such that the cleaning quality within existing manufacturing facilities varies locally and thus the effectiveness of the manufacturing process is demonstrably reduced.

Consequently, it is an object of the present invention to solve the above-mentioned problems of the state of the art and in particular to provide a filter device which is compatible for production facilities based on optical interaction and by means of which the risk of contamination within said production facility can be effectively reduced even when additional circulation gases are used. Furthermore, it is an object of the present invention, by using and adapting said filter device in a to be improved a production facility, in particular in a gas supply system of said production facility, to likewise optimize the flow properties of the gas to be used in such a way that not only production particles arising can be effectively separated from the existing working area of the production facility, but also a respective gas flow can be individually adapted to any circumstances existing within the production facility.

### DETAILED DESCRIPTION OF THE INVENTION

To solve the above-mentioned object, the features of the independent claims are proposed. The dependent claims relate to preferred exemplary embodiments of the present invention.

Here, the filter device of the present invention can preferably comprise at least one distribution element for the planar introduction of a process gas flow, i.e. a gas (e.g. hydrogen, helium, carbon dioxide, ethene or argon) that is usually to be introduced for manufacturing processes into the working area of the respective manufacturing facility, and a filter element for purifying the process gas to be introduced, preferably by avoiding material deposits within the gas feed lines to be used, which are preferably configured to improve the quality of the process gas flow to be used first, in particular by capturing potentially harmful material particles by the filter element, and to introduce the gas that is thus residue-free into the above-described working area over as large an area as possible by means of interaction with components of the distribution element. The present invention thus preferably forms an at least two-part device system that is capable, with the aid of a first element (the filter element), of preventing the penetration of harmful residual particles into the provided gas feed line (with the possibility of gas feed continuing), whereas a second element (the distribution element) additionally simultaneously ensures a gas flow profile that is as large as possible and thus of high quality. Consequently, it is possible with the present invention, contrary to the state of the art, to guide an existing process gas flow optimally over an existing construction process both in relation to the material components of the process gas flow and in relation to its fluid-dynamic properties, as a result of which ideal quality properties of the workpiece to be produced can be ensured.

Here, for the above-mentioned purposes, the described distribution element can first preferably comprise at least one perforated plate, which makes it possible for the distribution element in particular to fan out a process gas flow existing in the gas feed system and impinging on the filter device, preferably by means of multiple diffusion processes within the perforations existing in the perforated plate, for a large-area introduction into the working area of the manufacturing facility. Here, the general configuration of the mentioned perforated plate is first not restricted to a specific shape or geometry, but can be regarded at the outset as at least any type of three-dimensional structure that can implement a spatial redistribution of a gas flowing through based on a plurality of perforations. Particularly preferably, the perforated plate is a perforated plate or a perforated plate.

Accordingly, in a particularly preferred exemplary embodiment, the at least one perforated plate can be formed, for example, as an industrially manufactured, metallic, synthetic or perforated plate consisting of natural materials (wood, carbon, etc.) or as a perforated plate, for example according to DIN 4185-2 and DIN 24041, which can bring about a fluid-dynamic distribution effect by means of selectively introduced perforations and can thus bring about a regulatable widening of the process gas flow to be used. In a further exemplary embodiment, however, tissue-like or irregularly shaped materials, for example perforated polymer layers, lamellar plates or various textiles, can also preferably be used for this purpose in order to achieve an analogous effect, so that an individually adapted distribution element can preferably be used depending on the process gases to be used and the manufacturing facilities to be supported.

In order to be able to provide a process gas flow optimally set for a respective working process here, the properties of the perforated plate can furthermore preferably also be selectively adapted to the requirements of the respective manufacturing facility and/or the manufacturing processes to be carried out. Thus, for example, in a particularly preferred exemplary embodiment, at least the hole size of the existing perforations, their spatial distribution on the perforated plate and/or the thickness of the at least one perforated plate can be formed in such a way that, by changing or adapting one of the above-mentioned features, a change in the process gas flow profile flowing into the working area can likewise be generated, so that the properties of the process gas to be introduced can be actively influenced by the characteristics of the at least one perforated plate.

Based on these principles, the at least one perforated plate can accordingly be configured, for example, by means of the above-described diffusion effects and features of the at least one perforated plate adapted to the circumstances of the respective manufacturing facility or the manufacturing process to be used (e.g. dimensions of the working area, speed of the gas flow to be introduced, quantity of the material particles to be discharged), not only to generate an enlargement of the process gas flow to be introduced into the working area, but also to generate a flow profile adapted at least for the respective manufacturing process. Preferably, the at least one perforated plate can hereby be configured in such a way that, by flowing the process gas through the perforations of the perforated plate, in particular a temporally and/or spatially constant process gas flow is generated in the working area of the manufacturing facility. In other cases, it can moreover also preferably be possible that, by adding the perforated plate, for example, a laminar flow can also be formed within the working area, such that any turbulences within the process gas profile that are obstructive to the particle discharge process can be effectively prevented. In this respect, a gas influence within a manufacturing facility can already be generated by a single element of the invention, which is far more optimized in comparison with the state of the art, as a result of which the corresponding manufacturing quality can be increased equivalently.

The filter element likewise comprised by the filter device and to be used for particle filtration can furthermore preferably likewise be arranged in the vicinity of the distribution element, preferably on the distribution element itself or its at least one perforated plate, such that not only can the smallest possible own volume of the present filter device be achieved, but likewise the free space within the filter device that arises between the distribution element and the filter element and can thus potentially be affected by particle residues can be reduced to a minimum. Here, in a preferred exemplary embodiment, the filter element can particularly preferably be arranged on the side of the at least one perforated plate facing the respective process gas flow, such that the process gas flow generated by the perforated plate can preferably be introduced into the working area of the manufacturing facility without interference and/or interaction.

In order to be able to additionally implement the above-described shielding functions of the filter device, the filter element can further comprise at least one filter medium configured for particle filtration, for example a filter fleece, a polymer filter, an antistatic filter fabric or any other material that can be used as a particle filter, which at least allows the filter element to prevent the penetration of the last-mentioned material particles into the feed system (valves, pipes, etc.) that is to be protected and integrates the filter device. Thus, in an extremely preferred exemplary embodiment, the filter medium can have, for example, at least one mechanical pore provided with a predefined pore size, through which material particles flowing through the filter device can be captured by means of the filter element and thus effectively separated from said feed system, in particular during the unpacking process.

In a preferred embodiment of the filter medium, this pore size can in particular be configured such that any material particles entering from the working area into the inlet of the feed system (and thus into the filter device implemented there) can be effectively captured or received by the filter medium. In this respect, the pore size can in this case be configured, for example, such that the corresponding material particles are preferably completely blocked when impinging on the filter medium, for example by the pore size within the filter medium being configured to be smaller than the size of the material particles to be received (screen effect), such that an almost perfect efficiency of the filter medium can be achieved. In a further exemplary embodiment, the above-mentioned pore size can additionally in particular also have been selected such that, in addition to receiving the potentially harmful material particles, the process gas to be introduced into the working area of the manufacturing plant can likewise preferably continue to be let through the filter medium to be used without interference, whereby the filter device preferably remains usable both in the active state (gas supply active) and in the inactive state of the feed system (gas supply inactive) of the manufacturing facility.

Further advantages of the mechanical filtering structure thus generated can additionally also be generated by an additional optimization of the process gas flow to be used.

Thus, the previously described filter medium can, for example, likewise be configured, based on the flow properties of the process gas flow flowing through the filter device, to further homogenize the latter process gas flow preferably for the inlet into the working area of the manufacturing plant, such that, in addition to the expansion of the process gas flow and the thus enlarged effective area of the introduced process gas flow by means of the distribution element, a gas flow profile that is as even as possible can also be created by the filter device.

For this purpose, the composition of the filter medium can be configured, for example, such that a large number of collision processes of the corresponding process gas particles on the materials (e.g. the pores) of the filter medium can occur during the flowing of the process gas through the filter medium, whereby, according to the diffusion law, a higher entropy and thus an equalization of the local gas particle density within the process gas is achieved. In this respect, in an extremely preferred exemplary embodiment, the filter medium of the filter element can in particular also assume a double role and not only efficiently protect the integrating feed system of the manufacturing plant from penetrating material particles, but likewise also implement an improved, specifically homogenized flow through the working area.

The precise adaptation of the process gas profile by means of the filter medium can preferably take place in this connection, similarly to the properties of the at least one perforated plate of the distribution element, in particular by adapting any structural properties of the filter medium to the flow properties of the process gas flow flowing through the filter device. Thus, for example, in a first preferred exemplary embodiment, at least the thickness and/or the pore size of the used filter medium can be configured such that, depending on the properties of the gas to be homogenized (e.g. speed, pressure, cross-sectional area or content of the gas flow), a process gas flow homogenized in the working area of the manufacturing plant is formed. In a second exemplary embodiment, for this purpose, the pore geometry (e.g. structural orientations of the pores, spatial distribution or density within the filter medium) can also be adapted to the process gas flow, for example by using specifically selected materials, so that the above-mentioned homogenization can take place not only by the establishment of external but also internal properties of the filter medium.

Accordingly, it can be seen that by means of the features of the filter device, in particular by means of the multifunctional distribution and filter elements which can be adapted to the properties of the process gas flow to be used, an effective improvement of the process gas to be introduced into a manufacturing plant can be implemented, which, in addition to the efficient suppression of particle deposits within the respective gas feed system (and thus a potential risk of contamination), likewise also includes an optimization of the corresponding process gas flow. Furthermore, the filter device offers the advantage that, due to the small number of required device elements, a particularly compact construction can be implemented, so that the filter device can preferably be configured to be integrated into any type of manufacturing plant.

In a particularly preferred exemplary embodiment, the filter device can accordingly in particular also be configured such that, due to the extremely compact form, it is present as an autonomous device and can be integrated individually or independently of the structure of the respective manufacturing plant, into the manufacturing plant to be improved, but at least into its used process gas feed system.

In order to be able to ensure an extremely preferred improvement of the process gas flow and the above-described contamination protection here, the filter device can furthermore preferably also be configured to be integrated directly, i.e. preferably directly on the working area of the respective manufacturing plant, so that in particular the fanning effects generated by the at least one perforated plate can also be introduced into said working area preferably without interaction.

Thus, in a particularly preferred embodiment of the present invention, the filter device can for this purpose for example be configured to be integrated directly on a component of the manufacturing plant defining the working area of the manufacturing plant, for example a wall of a processing chamber used by the manufacturing plant or at least one inlet of the gas feed system into the working area, whereby a maximum effect of the above-mentioned effects of the filter device is achieved. In further preferred embodiments, it can moreover also be possible that a part of the filter device, for example the distribution element, particularly preferably but in particular the at least one perforated plate of the distribution element, is also configured to be connectable to the defining component of the manufacturing plant such that the filter device can act as a functional component of the manufacturing plant (for example as a component of the above-described process chamber wall) or even replace any components of the manufacturing plant by integration into the respective manufacturing plant, so that not only can further material costs be saved, but also the use of additional elements for adapting the filter device to the respective manufacturing plant can be avoided.

The integration of the filter device into the manufacturing plant itself can additionally in the preferred case be achieved by means of releasable fixing processes, for example simple screw connections, tensions based on mechanical, electrical or pneumatic interactions (for example by clamping levers to be introduced) or by fixing elements already present in the manufacturing plant, such as guide rails compatible with the filter device. This has in particular the advantage that an equally simple exchange of the filter device within the manufacturing plant is made possible by a simple attachment and removal of the filter device to and from the respective manufacturing plant or the associated gas feed system, so that an adaptation of the filter device to any changes within the manufacturing plant, for example in the case of a material change or a change of the process gas, can preferably likewise be achieved by simply replacing the existing (i.e. the currently integrated into the manufacturing plant) filter device with a newer, more compatible version.

In this respect, the filter device can correspondingly preferably be configured, in the case of changes within the respective manufacturing plant, in particular during the exchange of materials to be used, process gases or general working processes, to adapt the required process gas flow (preferably before the starting of the changed manufacturing process) to the new circumstances at least in that a filter device already integrated into the manufacturing plant is exchanged by a new filter device adapted to the mentioned changes (for example by means of using changed filter media or perforated plates), whereby an equally particularly cost-efficient and simple adaptation method is achieved.

In a further extremely preferred exemplary embodiment, it can additionally also be possible that the entire filter device does not have to be replaced for the above-mentioned exchange process, but rather only individual elements of the filter device can also be configured to be exchangeable, as a result of which the efficiency of said exchange process can be increased even further. For example, it can be possible that in the case of individual process changes within the manufacturing plant, such as for example the pure exchange of materials to be used, the actual process gas stream can remain unchanged, so that to maintain the desired filter device effects, only the comprised filter element or its filter medium would have to be adapted to the new circumstances (for example by equalizing the pore sizes to the newly to be used material).

In order to incorporate this case equally into the capabilities of the present invention, in a further exemplary embodiment, the filter device can also be configured in such a way that, in addition to or instead of the entire filter device, at least the distribution element (or its at least one perforated plate) and/or the filter element can also be arranged to be exchangeable within the filter device, so that an adaptation of the filter device to changes within the manufacturing plant can also take place by selective exchange of at least one of the above-mentioned elements.

A corresponding adaptation of the filter device or of one of the elements comprised by it can thus preferably be understood in the following at least as an exchange of the device and/or said elements by an optimized version.

The advantages of the above-mentioned adaptation process result here in particular from explicit requirements of the filter device within the respective manufacturing plant. Thus, for example, by a simple exchange of the filter element after a respective manufacturing process step, any material particles collected by the filter medium can be efficiently removed from the manufacturing plant or the gas feed system without having to carry out further complex cleaning processes, as a result of which a particularly cost-efficient cleaning mechanism can be implemented. Furthermore, a simple replacement of one of the previously described elements offers the possibility of developing the features at least of the filter element and/or of the distribution element in each case specifically for a predefined circumstance during the manufacturing process (for example the material particle size and the process gas properties to be used), so that a far more precise adaptation of the filter device to the properties of the respective manufacturing plant is made possible.

The exchange process itself can furthermore preferably additionally be carried out manually, but in particularly preferred embodiments also in an automated manner. In this respect, the filter device can, for example, preferably be configured to lay open at least a part of the filter device during the exchange process in order to exchange the filter device and/or at least one of the above-mentioned elements, so that a responsible operator can remove the element to be exchanged or the device to be exchanged and replace it with a new one. In a preferred exemplary embodiment, for this purpose, for example, one or more predefined introduction sections configured for introducing and removing the device elements can be implemented in the filter device, which sections remain accessible to the above-mentioned operator even after the integration of the filter device into the respective manufacturing plant and thus allow the operator to be able to carry out the previously described exchange process preferably at any time and without influencing the manufacturing process. In a further particularly preferred exemplary embodiment, however, it can also be possible that the above-mentioned exchange of the device or of the elements cannot be implemented by a single operator, but equally also by an automatism likewise implemented in the manufacturing plant or the filter device, for example a change mechanism configured for automatic exchange, so that an adaptation of the filter device can preferably also take place in a fully, but at least semi-automated manner.

Examples of such a change mechanism are generally not restricted to a specific technical mode of operation, but can generally comprise any type of device that enables a partially or fully automatable exchange process of the above-mentioned elements. In this respect, the filter device can preferably be provided, for example, with a mechanical change mechanism, for example a mechanical filter wheel or an additional robot arm, but in further cases also with devices based on pneumatic or electrical methods (for example electromagnets), so that a replacement of the elements contained in the filter device can preferably take place in a manner preferably adapted to the respective manufacturing plant. In further preferred cases, it can moreover also be possible that the above-mentioned change mechanism can also comprise an internal store for storing elements already used, to be reused and/or exchanged, whereby the exchange process can preferably also be carried out in a fully autonomous manner, i.e. without external influencing by an operator or a source detached from the manufacturing plant.

In order furthermore also to be able to ensure an extremely precise positioning of the individual elements in the filter device and thus a precise adaptation of the process gas flow flowing through the filter device, the filter device can furthermore also comprise at least one regulatable guide device (adjustable filter receptacle), preferably for the guided implementation and removal of the filter element and/or of the distribution element in or from a working position provided for the working operation of the filter device. By way of example, the guide device can comprise for this purpose a mechanical connection between the introduction section already mentioned above and configured for the external introduction and removal of a device element and the last-mentioned working position, so that when an element to be exchanged is introduced into the introduction section, the element can be introduced into the working position of the filter device preferably in an automated manner by means of the guide device.

In order likewise to be able to ensure preferably an exact alignment of the element to be introduced into the filter device, the guide device can furthermore also be configured in particular to guide at least the at least one perforated plate of the distribution element and/or the filter element for positioning at a respective working position only along a predefined, at least two-dimensional direction, but in a particularly preferred exemplary embodiment in particular one-dimensional direction, so that the above-mentioned elements are present in their preferred end position (the working position) preferably at all times in a predefined spatial orientation within the filter device. Accordingly, the above-described guide device can comprise for example at least one preferably horizontally aligned linear guide adapted to the device elements, such as a guide rail, a bearing or any other type of guide mechanism, which allows the guide device to restrict the degrees of freedom of movement of one of the device elements introduced into the filter device and thus to introduce it into the working position particularly efficiently. The introduction itself can here, as already mentioned, be carried out both manually by an operator and also in an automated manner by an internal change mechanism of the filter device or of the respective manufacturing plant. In addition, the guide device and/or the filter device can additionally also comprise a fixing mechanism, for example a clamping apparatus adapted to the respective device element or one of the releasable fixing possibilities already described above, so that at least the filter element and/or the distribution element can preferably also be fixed in an automated manner when the working position is reached.

Accordingly, it should be noted that, due to the extremely simple and compact construction of the filter device, combined with the effectively to be carried out adaptation of individual device elements to any changes carried out within the manufacturing facility (for example material or process gas change), in particular by efficient exchange of the at least one filter element and/or of the distribution element of the filter device, a particularly user-friendly and adaptable adaptation of the process gas stream to be introduced into the manufacturing facility can be ensured. Furthermore, the simple and accordingly cost-effective design of the filter device offers a number of extension possibilities.

Thus, as already described above, a minimum example of the claimed filter device to be integrated into the gas supply system of the manufacturing insert can provide at least one positioning of the filter element configured for filtration and homogenization on the perforated plate of the distribution element, wherein the filter element or the filter medium comprised therewith can here preferably be mounted on the perforated plate with respect to the process gas stream to be improved. In this respect, a device system provided with at least two device elements (filter medium & perforated plate) can be formed by the above-mentioned design, in which a process gas flowing through the filter device can initially be homogenized by means of the filter medium and separated from the material particles occurring during the manufacturing process and then introduced into the working area of the manufacturing facility in a planar manner, i.e. as wide as possible, by the interactions with the perforated plate.

In further embodiments of the filter device, however, it can also be possible that further device elements can also be configured to be introducible into the filter device, so that the process gas to be processed is preferably further optimized.

Thus, in a further preferred embodiment, the distribution element of the claimed filter device can for example also be equipped with at least one second perforated plate, which can preferably likewise be positioned on the filter element in the filter device and is thus capable of initially adapting the process gas stream to be processed already before impinging on the filter element. Here, the above-mentioned second perforated plate can optionally be formed equivalently to the first perforated plate of the filter device (for example by using the same hole sizes, distributions or plate dimensions), so that for example a symmetrically formed filter device and thus a gas flow profile to be defined particularly simply can be generated. In a further exemplary embodiment, however, it is also possible that the features of the second perforated plate preferably differ explicitly from those of the first perforated plate and rather are defined by the properties of the used process gas flow (speed of the flow, pressure, cross-sectional area etc.) as well as the features of the filter element positioned downstream and the first perforated plate.

The latter exemplary embodiment here has in particular the advantage that the process gas flow penetrating into the filter device can already be adapted in advance to the interactions within the claimed filter device by means of the perforated plate additionally introduced into the filter device. Thus, for example, depending on the selection of the hole sizes, the distribution of individual perforations or the thickness of the first perforated plate, the speed or the pressure of the process gas flow impinging on the filter device can already be changed such that optimal conditions for the subsequent homogenization and fanning out of the process gas flow by means of the filter element and the first perforated plate can be created, as a result of which the effectiveness of the claimed filter device is increased even further. Accordingly, the second perforated plate of the distribution element can preferably at least be configured to (actively) vary the process gas flow impinging on the filter device by means of presenting predefined features (e.g. distribution, size and length of the perforations) such that an improved process gas profile which is optimised at least depending on the features of the filter element and the first perforated plate and thus introduced into the working area of the manufacturing facility can be generated.

In this respect, a further preferred embodiment of the present invention can also provide a filter device equipped with at least two perforated plates, wherein each of the introduced perforated plates contain different predefined features and can thus be made usable for different effects within the claimed filter device. Accordingly, it should be pointed out that the claimed filter device, both in this at least three-element form and in the above-described embodiment defined by two device elements, thus forms a complex structure of a plurality of mutually dependent device elements, in which the different features of the latter can be so closely related to one another that an optimised, i.e. preferably pure, homogenized and large-area process gas flow can be formed merely by adapting all device elements to one another.

Further advantages of the above-mentioned embodiment can additionally again also result from the positioning and the orientation and construction of the individual device elements within the claimed filter device.

Thus, for example, as already mentioned above, the second perforated plate can preferably be positioned on the filter element, so that the changes of the process gas flow flowing into the filter device generated by the second perforated plate can be used for improved homogenization by means of the filter element. In order to likewise be able to ensure the greatest possible effect of the second perforated plate here, the second perforated plate can furthermore preferably also function in particular as an explicit gas inlet of the claimed filter device, so that the process gas to be introduced into the working area can preferably pass into the filter device or the working area solely through the perforations inserted in the second perforated plate (and thus depending on their properties).

The first perforated plate can additionally, for optimised fanning out of the finally cleaned and homogenized process gas, be formed equivalently preferably as a gas outlet of the claimed filter device, so that the processed process gas can preferably be introduced unhindered into the working area of the respective production plant. Accordingly, the first perforated plate can for this purpose for example also be configured to be integrated again in a wall of a processing chamber associated with the manufacturing plant or at least in the gas inlet of the gas supply system of the manufacturing plant, as a result of which the process gas optimised by the filter device and output by the second perforated plate can be introduced directly into the working area.

In order to additionally also be able to enable the most precise possible process gas adaptation by means of a suitable arrangement of the various device elements, the at least two perforated plates of the claimed filter device can furthermore also be aligned in particular preferably parallel to one another and, in a particularly preferred case, orthogonally to the flow direction of the process gas flow to be introduced. By means of such an orientation, in particular any shear flows within the process gas can be prevented particularly effectively, so that the effectiveness of the homogenization process by means of the filter element and the fanning out by the first perforated plate can be improved to a maximum. Furthermore, the above-mentioned orientation of the perforated plates enables in particular a configuration of the claimed filter device as a rectilinear, functional flow chamber, so that not only a flow profile partitioned or independent of the remaining gas supply system is generated between the two perforated plates, but the area formed by these two device elements (on account of the preferably uniform and homogeneous flow) can also be used ideally for measuring any process gas properties. In this respect, the claimed filter device, in a particularly preferred exemplary embodiment, can also preferably be configured to connect to at least one or a plurality of process gas sensors, for example for measuring the speed, the constituents or the pressure of the process gas used, or to integrate these into the flow path generated by the filter device, so that an optimal analysis of the process gas to be introduced can likewise be enabled by means of the filter device.

The filter element positioned between the two perforated plates can, however, in the above-described exemplary embodiment preferably furthermore be mounted at least on the first perforated plate or contacted on the latter, so that it is effectively avoided that material particles to be captured by the filter medium reach an intermediate space formed by the filter device and can thus accumulate within the filter device. In a particularly preferred exemplary embodiment, however, the filter device can also preferably be configured in such a way that the filter element in particular also fills the entire cavity generated by the two perforated plates within the filter device, as a result of which not only the above-mentioned material accumulation within the filter device is avoided, but rather likewise also any turbulences occurring at boundary layers (for example during the transition from air to solids) of the within the process gas can be effectively avoided.

In this case, in order to implement the above-described features, in a first preferred exemplary embodiment, at least the extent of the filter element can preferably be configured in such a way that the latter can be introduced in a form-fitting manner into the above-mentioned cavity of the filter device. In a further exemplary embodiment, however, it can also be possible that not the extents of the filter element, but in particular that of the cavity formed by the perforated plates can be configured to be adaptable, as a result of which preferably any form and size of the filter element to be used can be integrated into the claimed filter device.

Thus, the filter device can comprise, for the above-mentioned purpose, preferably for example an additional regulating mechanism, for example a clamping means connected to at least one of the two perforated plates, a clamping arm or a regulatable rail device, with which at least one of the perforated plates can be displaced or tilted along at least one axis and can thus be adapted positionally to the form of the filter element to be used. In this respect, the filter device can be configured by way of example by the above-described regulating mechanism to move the at least one displaceable perforated plate along the above-mentioned axis and thus preferably to adjust the distance between the two perforated plates in such a way that the filter element to be used can preferably be positioned in a form-fitting manner between the perforated plates. In further embodiments, the above-described regulating mechanism can additionally also be used to clamp the at least one filter element to be used preferably between the two perforated plates, in particular by means of bringing the at least one displaceable perforated plate closer to the other perforated plate, such that not only an extremely effective and cost-effective fixing method for introducing the filter element can be generated, but equally also the exchange of the latter can be implemented particularly simply and in a user-friendly manner by simply moving away the at least one perforated plate.

It can be seen in the following that, with the aid of the above-mentioned and claimed filter device, a wide spectrum of preferred advantages can be generated in relation to conventional gas introduction processes introduced into manufacturing plants, which, due to the simultaneously compact and efficiently adaptable device elements of the filter device, can preferably be introduced into any type of manufacturing plant based on optical interaction processes.

Furthermore, a manufacturing system containing the above-described filter device is likewise claimed below, which likewise has the above-mentioned advantages and can thus likewise be distinguished from conventional manufacturing systems.

Here, the claimed manufacturing system can likewise comprise at least one or a plurality of manufacturing plants based on optical interactions in accordance with the above-described definition and one or more embodiments of the above-defined filter devices integrated into the manufacturing plant. In this respect, the manufacturing plant of the claimed manufacturing system can firstly be regarded as at least one device, which comprises at least one light source (for instance a laser, a high-power LED or a solid-state emitter) for processing the mentioned workpiece materials and/or materials, one or more light paths generated by the light source and defined by means of a number of optical elements (mirrors, lenses, optical filters, etc.) and a working area defined for the manufacturing process and preferably separated from the external environment of the manufacturing plant, whereby the claimed manufacturing plant can preferably be identified with any conventional manufacturing plant based on optical interactions.

In a preferred embodiment, however, the corresponding manufacturing plant of the manufacturing system can also be configured in particular to be equipped at least for additive manufacturing of workpieces, such as for instance with the aid of selective laser melting (SLM).

In particular, the manufacturing plant based on optical interactions can for this purpose preferably comprise at least one processing chamber, in which the workpiece materials and/or materials required for workpiece production can be introduced and processed by exposure with the aid of the light source. In this respect, said processing chamber can in a particularly preferred case also be configured such that in particular the interior of the processing chamber can be used for the respective manufacturing processes and can thus define the present working area of the manufacturing plant.

Here, the processing chamber itself can moreover preferably, in particular in order to be able to meet the atmospheric conditions required for the SLM process, be configured to be completely or hermetically closable and in particular be equipped with a number of chemical and/or mechanical regulation elements, which enables the processing chamber of the manufacturing system to generate and preferably dynamically adapt an atmosphere required for the manufacturing process and to be formed within the working area (for example by supplying specific process gases and adjusting a pressure to be produced within the working area), whereby an extremely stable and error-free manufacturing process can be realized.

Specifically, the processing chamber can for this purpose comprise for example at least one gas inlet device coupled to a gas feed system of the manufacturing plant, by which the introduction of the above-described process gases can be regulated and thus also the aforementioned removal process of any material particle residues occurring within the working area can be implemented.

Thus, in a particularly preferred exemplary embodiment, said gas inlet device can be equipped for example with a gas circuit for providing process gases to be introduced into the working area of the manufacturing plant and at least the aforementioned gas feed system, for instance a plurality of valves and gas feed lines connected to the processing chamber and the gas circuit, which allow the gas inlet device to guide a predefined process gas or a process gas mixture into the interior of the processing chamber via an inlet contacted with the processing chamber and thus adapt the working area of the manufacturing plant to the atmospheric conditions of the respective manufacturing process.

In order to be able to equally use the process gas flow thus generated in the working area of the manufacturing plant for removing any material particles occurring here, the processing chamber can furthermore also comprise at least one gas outlet, for instance a further, preferably regulatable gas valve introduced into the processing chamber or a gas connection device, with which the process gas flow introduced into the working area can be removed again from the processing chamber and thus a continuous process gas flow set up for entraining/absorbing material particles occurring during the manufacturing process can be formed within the working area.

The general shape and positioning of any gas inlets or outlets within the manufacturing plant and the structuring of the aforementioned gas inlet device can preferably vary here depending on the manufacturing processes used and modes of action of the manufacturing plant. In a particularly preferred exemplary embodiment, however, at least the gas feed system or the gas feed lines comprised therewith and used for introducing the process gas can preferably already be formed flatly, that is to say with a comparatively large flow cross section (for example at least half of the processing chamber cross section to be used), such that on the one hand a flow profile of the process gas that is as wide as possible already forms in the gas feed system, but on the other hand the pressure occurring within the gas feed system can also be effectively reduced. Furthermore, the above-described gas outlet of the processing chamber can particularly preferably be positioned on a side wall of the processing chamber, preferably close to the base area of the latter, whereby the advantage is generated that the process gas flow generated by the gas inlet device can be guided in particular close to the manufacturing area and thus close to the particle source to be removed (the processed workpiece).

In a further particularly preferred exemplary embodiment, the process gas flow flowing through the working area of the manufacturing plant can additionally also comprise in particular not only one, but preferably a plurality of process gas flows which, depending on the selected manufacturing process, have properties to be distinguished from one another and can thus be used for different purposes. Thus, a preferred embodiment of the manufacturing plant can comprise by way of example at least one first primary process gas flow guided along the base area of the working area, in particular for removing particle residues at said base area of the working area, and a second secondary process gas flow spanning the entire processing chamber, which can preferably be configured to remove further particle residues in the rest of the entire processing chamber. In this respect, by the division of the process gas flow located in the processing chamber into a plurality of process gas flows thus generated, the advantage can thus be generated that, depending on the regional strength and degree of contamination of the particle deposits occurring in the working area, a flow profile specifically adapted to the above-mentioned properties of the deposit can be created. Accordingly, the primary process gas flow can by way of example preferably be equipped with a higher flow speed in comparison with the secondary process gas flow, in order to remove the material particles to be found more frequently at the bottom of the processing chamber more quickly and more efficiently. In contrast, the secondary process gas flow can by contrast preferably be formed as a slower, but far more planar and, in a particularly preferred case, also continuous process gas flow, as a result of which an extremely uniform removal of particles can be ensured.

The filter device configured to improve the process gas flow and to protect the gas introduction system from any material deposits can additionally preferably be integrated directly in the gas introduction system, i.e. in at least one valve of the gas introduction system, so that the process gas flow to be introduced into the working area of the manufacturing plant preferably comes into contact directly with the filter device, flows through the latter and can thus optimize its properties according to the principles already mentioned above. In order to further be able to ensure the greatest possible effect of the filter device here, the claimed filter device can additionally, in a preferred exemplary embodiment, also be connected in particular directly to the processing chamber of the manufacturing plant, such that the process gas flow optimized by the filter device can preferably be introduced into the working area without interaction.

Thus, in an extremely preferred exemplary embodiment, the filter device can for this purpose in particular likewise be configured to be integrated at least on a wall of the processing chamber, such that the above-described optimized process gas can preferably pass directly into the processing chamber after flowing through the filter device. More precisely, the at least one perforated plate of the filter device configured to fan out the process gas flow can for this purpose by way of example preferably be configured to be introducible onto the above-mentioned wall of the processing chamber, as a result of which said perforated plate can be used not only as a direct inlet of the process gas into the processing chamber, but likewise also as a functional component (i.e. at least as a part) of the processing chamber.

In this respect, a preferred inlet process of a process gas to be introduced into the working area of the claimed manufacturing plant can in the present invention contain an at least three-stage introduction mechanism. Thus, in a first step, selected process gas can be let through the gas inlet device, for example from the aforementioned gas circuit, into the gas feed system likewise comprised in the gas inlet device, such that the respective process gas can be guided in the direction of the processing chamber via the valves and gas feed lines contained in the gas feed system. In a second preferred step, the introduced process gas within the gas feed system can thereupon impinge on the filter device fluidically connected to the gas inlet device (i.e. for example integrated in the gas feed system) and consequently be introduced into the filter device on the basis of the gas stream generated by the gas inlet device, as a result of which the process gas stream can preferably at least be homogenized and fan out by means of the implemented filter and distribution elements and thus be optimized for the flow through the working area of the manufacturing facility. In a preferably last step, the optimized process gas can additionally be led out of the at least one perforated plate of the filter device and thus guided in an improved manner into the processing chamber of the respective manufacturing plant, such that a process gas stream preferably optimally adapted to the conditions of the respective manufacturing process can be formed.

Accordingly, the above-described combination of gas feed system connected to the processing chamber of the manufacturing plant (or the gas feed device used for this purpose) and the filter device preferably integrated therein has the particular advantage that the gas feed system by means of the filter device can not only be effectively protected against any material particle deposits, but likewise also the process gas stream guided through the latter can be optimally aligned with the conditions within the processing chamber.

In addition, as already described above, the extremely compact and preferably easily exchangeable construction of the claimed filter device enables a particularly simple adaptation of the device features of the filter device to any changes to be carried out within the manufacturing facility.

Thus, as mentioned, it is for example possible that individual device elements of the filter device and/or the entire filter device itself in the integrated state can preferably easily be exchanged for a respective optimized version (with regard to the above-mentioned changes within the manufacturing facility), such that, for example in the course of a material change or in the event of a change in the process gas to be used (or the properties thereof), the filter device can be adapted extremely effectively and cost-effectively to the new conditions. In addition, it can in particular also be possible that the gas inlet device implemented in the manufacturing facility can also be configured to adapt the flow properties of the process gas stream to be introduced, preferably depending on the properties of the filter device, i.e. in particular the features of the distribution element and/or of the filter element, whereby the mode of operation of the filter device can be further improved.

In this respect, in a particularly preferred exemplary embodiment, the gas inlet device can for example also preferably be equipped with at least one or more control devices, which preferably allows the gas inlet device to selectively change predefined properties of the process gas stream to be introduced into the filter device and thus to adapt to any new features of the filter device. Thus, for example, the at least one control device can preferably be configured to be coupled to the valves of the gas feed system, whereby the control device is able, for example preferably upon receipt of a change signal, to adapt the above-mentioned properties of the process gas stream (e.g. the pressure, chemical components etc.) to new features of the filter device and thus to implement a process gas stream optimally aligned with the used filter device at any time. Conversely, however, as already described above, the filter device can also preferably be configured to be adaptable to the properties of the process gas to be introduced, such that a control system based on a plurality of adaptation possibilities can be generated.

The precise adaptation process to be carried out by means of the control device can again vary here depending on the manufacturing plant to be used and the manufacturing processes used there. In a first exemplary embodiment, however, it can at least be possible that the above-mentioned adaptation of the process gas stream can take place for example by a manual activation signal, for example preferably by manual input of the above-mentioned change signal to the control device. In this respect, for example, an operator who has already carried out an adaptation on the filter device, after completion of the adaptation of the filter device, can likewise transmit for example a predefined signal (the change signal) coordinated with the adaptation carried out to the control device, whereby the latter carries out corresponding adjustments in the gas feed system. In further cases, it can moreover also be possible that the changes carried out by the control device are also preferably carried out in an automated manner, for example in that any adaptations within the filter device can be detected by integrated sensors and, by means of automated data transmission, can be used to create an individual change signal (e.g. by using internal databases).

Furthermore, on the basis of the above-mentioned properties of the claimed manufacturing plant, and of the filter device integrated therein, a number of method steps are claimed, which can likewise be assigned to the claimed invention and can thus likewise be distinguished from method steps of conventional manufacturing plants or filter devices based on optical interactions.

More precisely, the claimed method steps relate to a method for adjusting an atmosphere within a manufacturing facility based on optical interactions, in particular a SLM facility, comprising at least one light source configured for manufacturing a workpiece, a plurality of optical elements for controlling a light path emanating from the light source and a processing chamber defining a working area of the manufacturing facility, wherein the method steps can comprise at least:
integrating a filter device according to the above-described features on at least one wall of the manufacturing facility based on optical interactions;
generating a regulated process gas flow into the working area of the processing chamber by introducing a process gas flow guided through the filter device into the processing chamber; and
regulating the process gas flow by adapting the properties of the distribution element and/or of the filter element of the filter device.

Furthermore, further method steps likewise claimed can comprise at least the activities:
regulating the process gas flow to be introduced into the filter device by means of a gas inlet device depending on the properties of the distribution element and/or of the filter element of the filter device;
exchanging the at least one perforated plate and/or the filter element before a material change in the manufacturing facility, wherein the exchanged perforated plate and/or the filter element is adapted to the material to be used.

In a further advantageous embodiment, a manufacturing system is proposed for manufacturing a workpiece with a manufacturing facility based on optical interactions, in particular a SLM facility. Here, the manufacturing system can comprise: a manufacturing facility based on optical interactions comprising at least one light source configured for manufacturing the workpiece and/or one or more optical elements for controlling a light path emanating from the light source and/or a processing chamber defining a working area of the manufacturing facility; and at least one filter device. Here, the filter device can be integrated on (or in) a wall of the processing chamber.

The manufacturing system can additionally comprise a first sensor system. The first sensor system can be equipped with one or more sensors for detecting and/or determining the process variables (in particular the properties of the gas supplied or to be supplied into the processing chamber).

A process gas supplied into the processing chamber is first guided into the fluid chamber or an inlet area before this gas flows through the filter device into the processing chamber. Here, the first sensor system can be arranged in the area of the fluid chamber (or of the inlet area) of the gas supply and/or upstream of the filter device. Thus, the first sensor system can be arranged behind the filter device, protected from the influence of process by-products (which are present, for example, in the processing chamber). In the area of the fluid chamber (or of the inlet area), a reliable detection of measured values and/or process variables can thus take place by the first sensor system.

The manufacturing system can have a fluid chamber (or a gas inlet box or an inlet area), which is arranged adjacent, preferably directly adjacent, to the processing chamber (i.e. the working area of the manufacturing plant or the construction space). Here, the fluid chamber can be connected to the gas inlet device and therefore to a gas circuit for providing process gas to be introduced into the working area of the manufacturing plant.

The fluid chamber preferably has an upper wall (arranged substantially horizontally) and one or more adjacent side walls. Particularly preferably, the filter device is formed here as part of a wall of the fluid chamber and at the same time as part of a wall of the processing chamber. Preferably, the sensors are arranged at least on the upper wall and/or on at least one side wall of the fluid chamber.

The sensors of the first sensor system can additionally be arranged on the upper wall and/or side wall in such a way that they protrude from the wall surface into the fluid chamber. As a result, the measurement accuracy can be further improved.

Advantageously, the fluid chamber can have a fluidic connection to a gas circuit (which can preferably have an internal filter system for processing the process gas and a pump for conveying the process gas) via a connection opening.

In addition, the fluid chamber can have a stop wall positioned in front of the connection opening, on which the process gas flowing into the fluid chamber can impinge initially after being output from the gas circuit in order thus to be able to effectively reduce any turbulences of the process gas flow to be used already within the fluid chamber. Advantageously, at least one sensor of the first sensor system can be arranged directly above the stop wall on the upper wall of the fluid chamber.

The advantageously arranged first sensor system can comprise one or more pressure sensors. The pressure sensors can be configured to detect the process pressure and/or the filter device differential pressure. Further advantageously, the sensor system can have one or more sensors for detecting the oxygen content in the fluid chamber/processing chamber and/or for detecting the oxygen content in the area of the filter.

In addition, at least one sensor can be provided for detecting the gas flow from the fluid chamber. Furthermore, at least one temperature sensor can be provided for detecting or determining the gas temperature and/or the dew point of the process gas and/or the construction space temperature.

In addition, a second sensor system can optionally also be provided for determining the process variables, wherein this second sensor system is arranged outside the fluid chamber and can in particular be arranged in the processing chamber.

Method steps for manufacturing a component by means of an above-described manufacturing system can additionally comprise at least one or more of the following steps: regulating the process gas flow to be introduced into the filter device by means of a gas inlet device at least partially depending on detection values of the first sensor system; generating a regulated process gas flow into the working area of the processing chamber by introducing a process gas flow guided through the filter device into the processing chamber, at least partially depending on detection values of the first sensor system; regulating the process gas flow by adapting the properties of the distribution element and/or of the filter element of the filter device, in particular by exchanging the filter element at least partially depending on detection values of the first sensor system; controlling the laser light source at least partially depending on detection values of the first sensor system.

### BRIEF DESCRIPTION OF THE FIGURES

FIG. 1: shows a cross-section of a manufacturing facility based on optical interactions, specifically a SLM facility, with a filter device integrated on a wall of the processing chamber;

FIG. 2: shows a three-dimensional cross-sectional view of the optical manufacturing facility of FIG. 1;

FIG. 3: shows FIG. 2 with additional flux lines for marking the primary and secondary process gas streams used in the manufacturing facility;

FIG. 4: shows a further exemplary embodiment of a manufacturing facility integrated with the filter device as a three-dimensional cross-sectional drawing, wherein the manufacturing facility likewise comprises a planar gas supply device;

FIG. 5: shows the manufacturing facility of FIG. 4 in a vertically mirrored view;

FIG. 6: shows a two-dimensional cross-sectional drawing of the filter device of FIGS. 4 and 5;

FIG. 7 shows a further design of the manufacturing facility.

### DETAILED DESCRIPTION OF PREFERRED EMBODIMENTS

Exemplary embodiments of the present invention are described in detail in the following with reference to exemplary figures. The features of the exemplary embodiments can be combined as a whole or partially and the present invention is not restricted to the described exemplary embodiments.

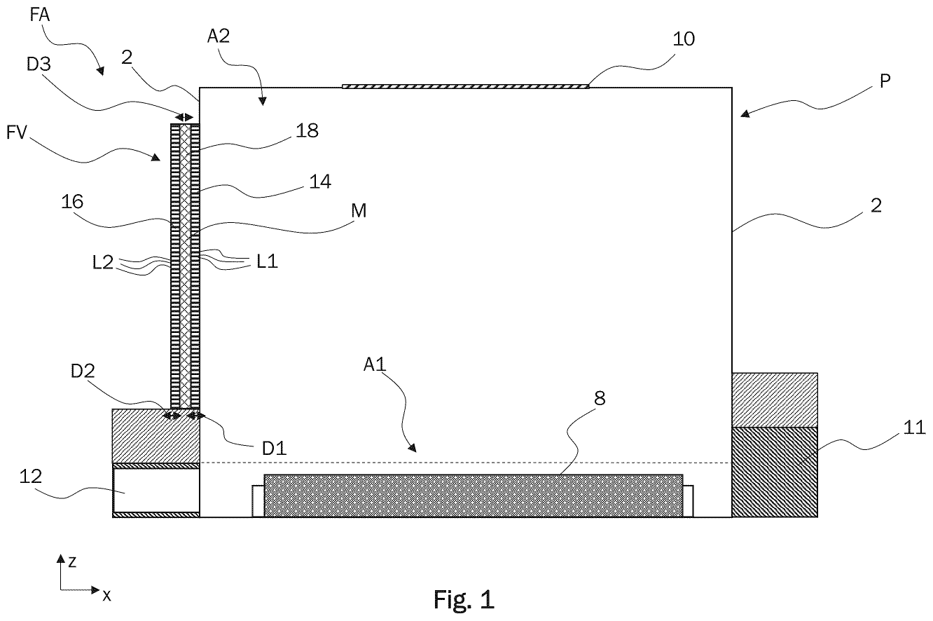

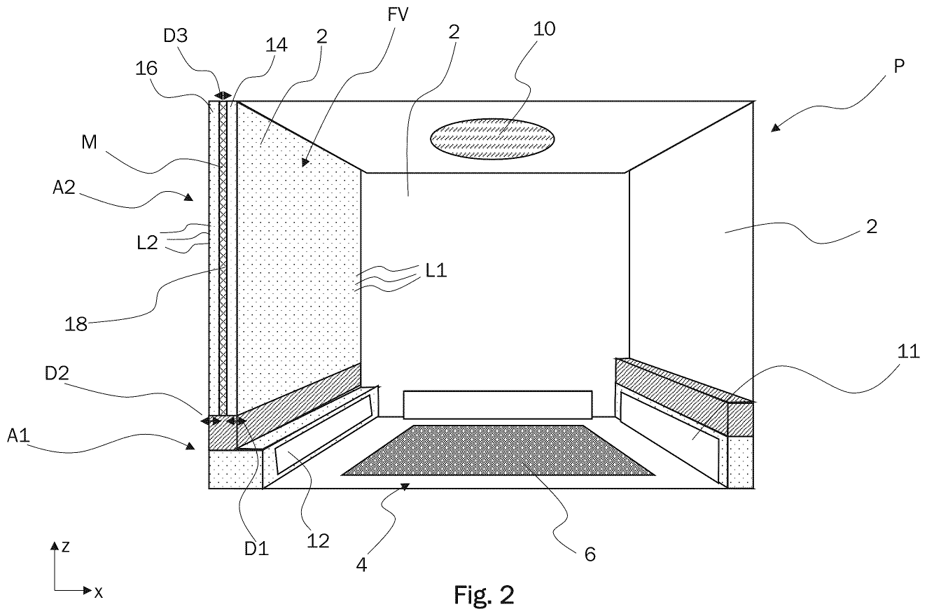

FIGS. 1 and 2 show a schematic embodiment of a first manufacturing facility FA based on optical interactions, specifically a manufacturing facility for selective laser melting, according to the claimed invention, in which a material to be processed (represented here as material layer 6) can be produced or processed by means of optical irradiation in a working area 4 of the manufacturing facility FA.

For this purpose, manufacturing facilities, such as the manufacturing facility FA represented in FIGS. 1 and 2, provide at least one (laser) light source, which, via a control system coupled to the manufacturing facility FA, generates a light beam modified for interaction with the material to be processed and this light beam is focused, with the aid of various optical elements preferably integrated in a scanning head, such as focusing or scattering lenses, mirrors, optical filters, etc., via a predefined light path onto the material mentioned above and usually positioned in the working area 4. The processing or production of the material/workpiece thus exposed by the focused light beam then takes place by means of local and preferably sequential plastic deformations of the material introduced into the working area 4.

Thus, for example, in the SLM facility represented, for producing any three-dimensional workpiece, the material to be processed is first applied in powder form in a thin material layer 6 into the working area 4, preferably onto a vertically movable base plate, and is positioned by means of movement of said base plate to a processing height corresponding to the light path of the light source. For processing, the material layer 6 to be processed is then locally remelted by means of the above-mentioned light beam focused in the present manufacturing facility through the protective glass 10 onto the material layer 6 and, after solidification, forms a solid material layer, on which, in subsequent process steps and with the aid of a coater 8 likewise located in the manufacturing facility FA, additional material layers are again applied and these are repeatedly melted together with the aid of the focused light beam until a desired three-dimensional material form (the workpiece) results.

As already mentioned, however, due to the above-described manufacturing process, usually in SLM facilities according to the state of the art, the problem arises that any process residues arising during manufacturing, such as, for example, soot or material particles entering the atmosphere, can have a negative effect on the processing quality of the respective manufacturing facility FA, since, for example, material deposits thus arising on the protective glass 10 or changing refractive indices within the manufacturing atmosphere can result in disadvantageous refractions of the processing light beam. Furthermore, the likewise existing penetration of material particles into any process gas feed systems forces a likewise complex and also cost-intensive cleaning of the latter, since otherwise, in the case of arising material changes, a high risk of contamination by residual particles must be assumed.

In this respect, to solve the above-mentioned problems, the device combination of optical manufacturing facility FA and the filter device FV as, for example, in FIGS. 1 and 2 is proposed.

Here, according to the exemplary embodiment shown there, the manufacturing facility FA comprises in particular the working area 4, in which a material layer 6 to be introduced can be processed by means of the above-described manufacturing process and can be used for producing a preferably three-dimensional workpiece. In order to likewise be able to generate an atmosphere required or at least advantageous for the manufacturing process here, the working area 4 is furthermore embedded in the preferably completely and hermetically lockable processing chamber P, which completely encloses the working area 4 by the processing chamber walls identified by 2 and thus in particular allows process gases or atmospheric conditions (for example a predetermined pressure) supplied to the working area 4 to be maintained within the processing chamber P and thus in the manufacturing facility FA.

In order to introduce these mentioned process gases, the manufacturing facility FA in the present exemplary embodiment is equipped with two gas inlets embedded in the processing chamber P and designated by 12 and 13, which are connected to a gas circuit of the manufacturing facility FA via two preferably separate, but in further cases also contiguous or even identical gas inlet devices GV and consequently make it possible to introduce a plurality of predefined process gas streams into the processing chamber P. The process gas is preferably conveyed continuously in the circuit between the processing chamber and a filter system for processing the process gas (gas circuit).

Here, the process gas streams thus introducible into the working area 4 of the manufacturing facilities FA have important functions in the illustrated embodiment. The main task of the process gas flow is the removal of welding fumes, condensate and welding spatters from the processing chamber. In order to maintain the oxygen concentration (e.g.: <0.05% residual oxygen content), there is preferably a separate oxygen monitoring and flooding. A further requirement on the function of the process gas guidance is, in the case of maximum removal of condensate, etc., that powder bed allow untouched so that no powder is conveyed into the filter system. In this respect, it is to be understood that the flow properties of the process gases to be introduced (for example the flow profile, speeds, extents of the process gas etc.) are important in the present invention both for the instantaneous (presentation of the process gas) and for the long-term technical quality assurance of the manufacturing process.

Furthermore, the process gas flows to be introduced through the two gas inlets 12 and 13 can likewise also differ from one another in principle.

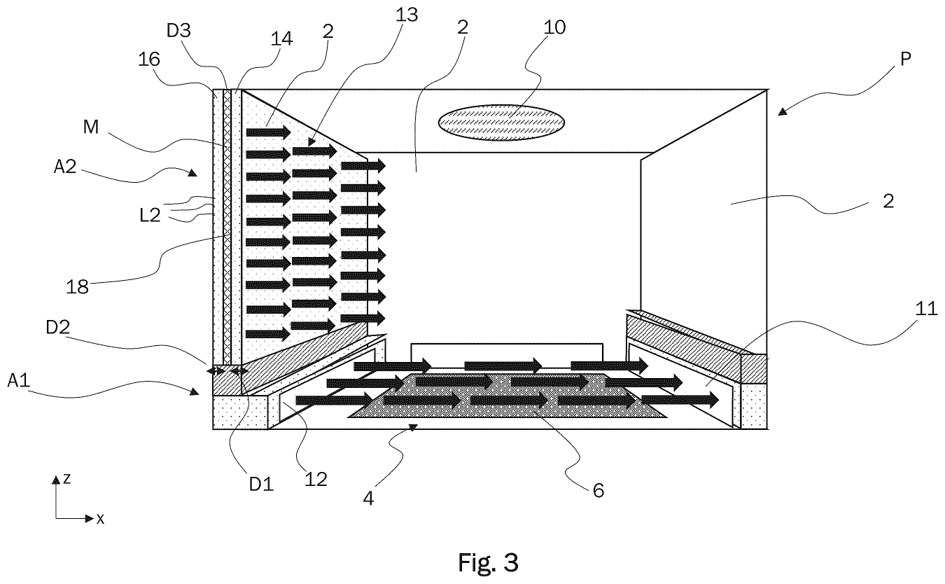

FIG. 3 shows for this purpose a schematic representation of the flow profiles let into the processing chamber P through the gas inlets 12 and 13. Thus, in the exemplary embodiment shown, for example, a first process gas flow, also called primary process gas flow F1, which is stronger in relation to the second gas inlet 13 is generated by the gas inlet 12, which is guided primarily along the base area of the working area 4 identified by A1 on account of the gas inlet 12 positioned close to the bottom of the processing chamber P and can thus predominantly assume a volume in the surroundings of the material layer 6. This has in particular the advantage that the removal (or extraction) of welding fumes and welding spatters immediately after formation is already possible by the primary process gas flow F1 positioned close to the material layer 6. In this respect, the primary process gas flow F1 in the present invention firstly forms a main flow with which a large part of the process residues occurring, such as welding fumes, condensate and welding spatters, can be removed.

The secondary process gas flow F2 introduced from the second gas inlet 13 can by contrast differ from the above-described primary process gas flow F1 in such a way that the former can extend in particular as extensively as possible, that is to say preferably over the entire, but at least over an upper portion A2 of the processing chamber P, as a result of which any residues which cannot be achieved by the primary process gas flow F1, for example upwards rising smoke, are likewise efficiently captured by the secondary process gas flow F2. In this respect, the two process gas flows F1 and F2 let into the processing chamber P in the present invention thus form two flow profiles to be distinguished from one another and preferably set up to fulfill different objects, as a result of which the advantage is generated that an individual improvement of the particle cleaning mechanism generated by each of the above-mentioned flows can be implemented by selective adaptation of said flows.

In order to remove the above-described process gas flows F1 and F2 again, the processing chamber P is additionally likewise equipped with a gas outlet 11 which is positioned opposite the gas inlets 12 and 13 and which in particular makes it possible to guide the primary and secondary process gas flows F1 and F2 out of the processing chamber P and thus likewise to remove the material particles captured by said gas flows from the working region 4 of the manufacturing facility FA. For this purpose, the gas outlet 11 can preferably also be equipped with a predefined negative pressure, which in particular allows the manufacturing facility FA to remove a preset amount of process gas per unit time from the processing chamber P and thus preferably to keep the process gas concentration in the working region 4 at a constant level. In further preferred exemplary embodiments, it can additionally also be possible for the gas outlet to be coupled to a recycling system in which the process gas led out of the processing chamber can be cleaned and then fed again into the gas circuit of the above-mentioned gas feed device GV.

In order to additionally improve the flow profile of the secondary process gas flow F2 even further, in the exemplary embodiment of the manufacturing facility shown in FIGS. 1 to 3, the gas inlet 13 is equipped with a preferred embodiment of the likewise claimed filter device FV. Accordingly, in the present representation, at least the secondary gas flow F2 already shown is formed by means of the filter device FV or defined more precisely by the latter.

In further exemplary embodiments, however, it can also be possible for further gas inlets, such as for instance the gas inlet 12, to be equipped with a filter device FV, such that the positioning of the latter does not have to be restricted only to this one exemplary embodiment.

Here, the filter device FV in the present case is formed to be integrated in particular in the side wall 2′ of the processing chamber. More precisely, in the present case the integrated filter device FV forms the at least one side wall 2′ of the processing chamber P after the integration into the processing chamber P in particular itself, such that the filter device FV can be regarded as an integral constituent part of the illustrated manufacturing plant FA. This consequently has in particular the advantage that a particularly planar process gas profile can be produced by the extremely large effective or gas inlet area of the filter device FV, which process gas profile can likewise be guided into the processing chamber P as unhindered as possible on account of the direct contact with the working area 4.

Functionally, the illustrated filter device FV additionally in the illustrated embodiment is composed explicitly of the three-element form already described above: a filter element 18 is positioned between two perforated plates 14 and 16, illustrated here as perforated plates, which filter element, equivalently to said perforated plates, assumes the size of the side wall 2′ and is thus formed functionally over the entire side wall 2′. Here, in the present case the filter element 18 is configured in particular as a replaceable filter fabric, for instance an at least two-dimensional filter nonwoven, with a predefined mechanical pore of the pore size M and a filter width of the length D3, which filter fabric makes it possible, depending on the above-mentioned features of the filter element 18, both to absorb process residues passing into the filter device FV into the filter fabric and, on account of the diffusive properties of the pores embedded in the filter element, to efficiently homogenize the process gas flowing through the filter device FV. Correspondingly, the filter element 18 or the filter fabric comprised by the latter is configured in the present invention in particular such that, on account of specifically adapted features (for instance the above-mentioned pore size M, the filter width D3, but also further properties, such as for example the density of the filter fabric), it can carry out the above-mentioned dual task and thus function both as a homogenized and as an efficient particle filter. For this purpose, for example at least the pore size M of the filter element 18 can have been chosen to be smaller than the particle size of the material used. Furthermore, it is likewise possible for the filter element 18 to be equipped with a specific, predefined pore pattern that promotes the homogenization of a gas flowing through.

The perforated plates 14 and 16 of the filter device FV are furthermore in contact with the filter element 18 in a planar manner in the illustrated form. In this respect, the filter device FV in the present case forms a rectilinear fluid chamber in which both the filter element 18 and the two perforated plates 14 and 16 are aligned parallel to one another and in particular orthogonally to the process gas flow to be introduced into the working area, as a result of which a particularly uniform distribution of the process gas can be achieved and the occurrence of disadvantageous shear forces can be effectively prevented.

The first perforated plate 14, which is aligned toward the inner side of the processing chamber and functions equally as such, furthermore has the width D1 and is equipped with predefined perforations L1, for instance punched-in perforations, which allows the perforated plate 14 to fan out the process gas previously homogenized by the filter element 18 downstream and thus preferably to introduce it directly into the processing chamber P. In this case, the abovementioned properties of the perforated plate 14 are preferably adapted at least to the features of the filter element 18 already described above (for instance the pore size M and the filter width D3), such that the process gas flow passing through the filter element 18 to the perforated plate 14 can preferably be optimally processed.

The second perforated plate 16 positioned upstream of the filter element 18 furthermore likewise has a predefined width D2 and perforation L2, which differ from those of the first perforated plate 14, but can also correspond in specific exemplary embodiments. Here, the second perforated plate 16 functions in the given case in particular as an upstream fan-out element which is connected to the gas supply system (not shown) of the gas supply device GV described above and through which the process gas provided by the gas supply device GV impinges for the first time on the filter device FV and distributes the latter through the perforations L2 as planarly as possible along the filter element 18.

In this respect, the interaction processes within the present filter device FV firstly provide that a specific process gas flow provided by the gas supply device GV impinges on the perforated plate 16 connected to the gas supply device GV (or the gas supply system thereof) and is homogenized by the latter on account of the interactions at the present perforations L2. The process gas flow then passes to the filter element 18 (which is preferably a filter fleece), which further filters the process gas flow, such that after emerging from the filter element a preferably uniform gas flow profile is generated. The further flow of the homogenized gas through the perforated plate 14 additionally widens the gas flow profile described above once again, such that finally the (secondary) process gas flow preferably filling the entire processing chamber can be guided in the working area 4. The main task of the filter element 18 during the construction process is thus the homogenization of the process gas flow. Here, the process gas flows through the filter element along a first direction. Furthermore, the filter element is also used as a filter or protection against mixing with powder residues, specifically during unpacking (unpacking process) of the workpiece or construction job.

Blocking/filtering of the particles is thus brought about along a second direction, which is preferably opposite the first direction. Since powder can be swirled up during the unpacking process, the filter element 18 is intended to prevent the powder from passing for example from the processing chamber into the provision area (in particular gas circuit, box etc.) of the secondary flow. The filter element 18 is thus provided as a type of membrane. The process gas is let through the one side of the filter element 18 (i.e. the side facing away from the processing chamber) (with the advantage of homogenizing the flow during the introduction into the processing chamber), and additionally, during the unpacking process, no powder can pass from the opposite direction (i.e. out of the processing chamber and thus through the side facing the processing chamber) into the feed elements/boxes of the secondary flow, since the latter are blocked by the filter element 18.

In this respect, it can be seen that the present filter device forms a device system with a plurality of device elements which are dependent on one another and adapted to one another, which, on account of the multifunctional properties of said device elements, enable the generation of a process gas flow which is aligned with the working area 4 and can be selectively adjusted and thus, in comparison with the state of the art, create improved atmospheric conditions within the processing chamber P to be used.

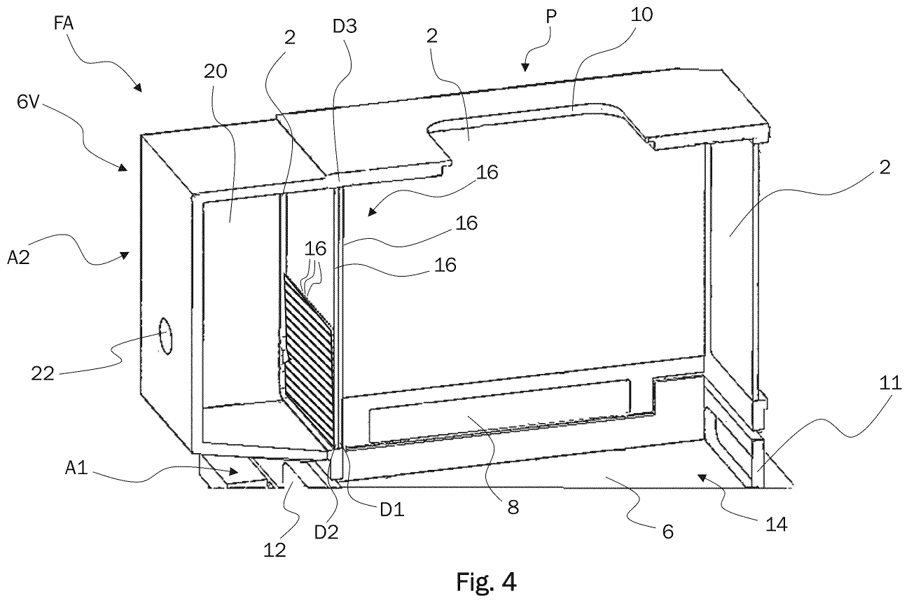

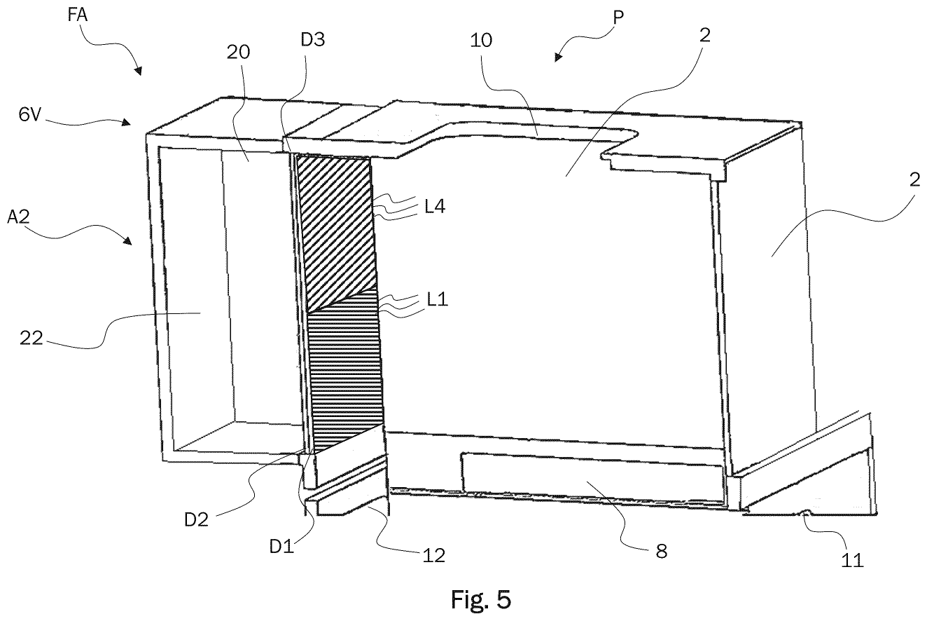

FIGS. 4 and 5 additionally show a further exemplary embodiment of the claimed manufacturing facility FA. Here, the embodiment illustrated in these figures differs in particular from the manufacturing facility shown in FIGS. 1 to 3 in such a way that the perforated plates 14 and 16 in this case are not equipped with a perforation formed over the entire plate, but said perforations differ in particular spatially. Thus, for example, the perforated plate 14 in this case has a first perforation L1 formed in the lower half of the perforated plate 14 and denoted by L1, whereas the upper half of the plate is equipped with a second perforation L4. Here, the two perforations L1 and L4 can differ in particular in the hole size used, the distribution of the perforations, their density or else also in the width of the plate used, as a result of which in particular the advantage is generated that the process gas flow profile generated by the perforated plate 14 can be adapted even more selectively (i.e. by combining different, spatially separate properties of the perforated plate 14).

Furthermore, it can additionally likewise be possible for a part of the perforated plate to have no perforations at all. Thus, for example, it is shown in FIG. 4 that the perforated plate 16 of the illustrated filter device FV contains an upper portion into which no perforations at all have been let, such that the process gas flow to be introduced into the filter device FV by the gas feed device GV can pass into the filter device FV only through a lower portion of the perforated plate 16. Accordingly, in the present case, an efficient gas inflow is generated by a selective local cutout of any perforation or other features within the filter device FV, which gas inflow can increase the effectiveness of the filter device FV even further.

Furthermore, FIGS. 4 and 5 show a preferred exemplary embodiment of the gas feed device GV connected to the filter device FV or integrating the latter. More precisely, the abovementioned figures show a portion of the gas supply system comprising the gas feed device GV, which gas supply system has been realized in the present exemplary embodiment as a planar flow chamber 20. Here, the size of the described flow chamber 20, in particular in the vicinity of the filter device FV, is adapted to the size of the filter device FV and preferably has the same extents as the perforated plate 16 in contact with the latter. This extremely planar embodiment of the gas supply system in this respect in particular has the advantage that the process gas flow to be introduced into the filter device FV can be scattered widely even before entering the perforated plate 16 and can thus be let into the filter device FV in a planar manner. Furthermore, an excessively large pressure build-up within the gas supply system is thus avoided.

In order furthermore to be able to provide the process gas to be used, the illustrated gas supply system is furthermore connected to a gas circuit (which preferably has an internal filter system for processing the process gas and a pump for conveying the process gas) via a connection opening 22. In addition, a stop wall (not illustrated) positioned in front of the connection opening 22 is mounted in the illustrated fluid chamber, on which the process gas flowing into the fluid chamber impinges initially after being output from the gas circuit and can thus effectively reduce any turbulences of the process gas flow to be used already within the present gas supply system.

In order additionally to be able to continue to control the inlet of the process gas efficiently, the gas feed device GV, as already mentioned above, can furthermore comprise at least one control device for adapting the properties of the process gas to be introduced through the gas circuit. In this respect, the gas feed device can for this purpose in particular be configured to adapt the properties of the process gas guided out of the gas circuit, in particular the flow velocity, the pressure or the constituents of the process gas, to the properties of the filter device or generally to the properties of the manufacturing facility, so that a further selective control of the process gas flow profile to be generated can also be implemented by the adaptation of the gas feed device GV.

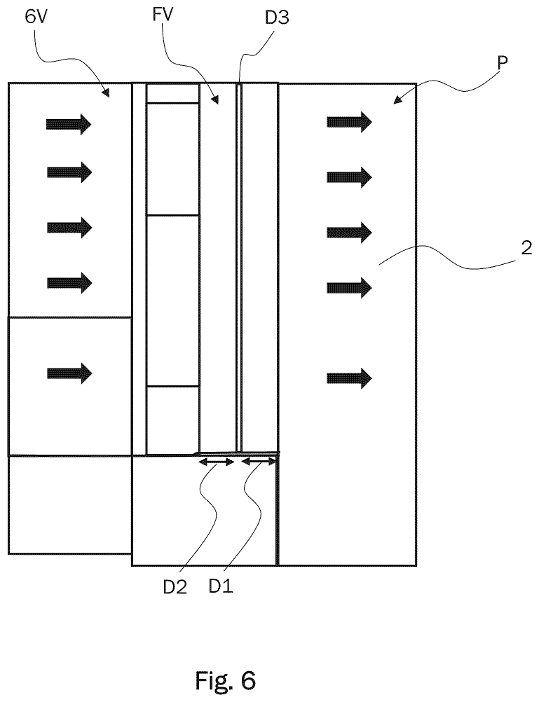

FIG. 6 additionally again shows a two-dimensional cross-sectional profile of the filter device FV already illustrated in FIGS. 4 and 5.

As can be seen here, the two perforated plates 14 and 16 and the filter element 18 also form in this case a device system oriented parallel to one another and orthogonally to the process gas flow direction, such that the process gas flow can be guided as efficiently as possible from the fluid chamber 20 through the filter device FV into the processing chamber P. Furthermore, the clamp-like positioning of the two perforated plates 14 and 16 offers the possibility of configuring the filter element 18 in particular also in a particularly simple manner.

Thus, for example, in the present exemplary embodiment, the filter element 18 formed as a filter fabric can only be introduced into the cavity between the two perforated plates 14 and 16 and removed again from the latter for adapting any process properties. The perforated plates 14 and 16 thus serve both as an element for fluid processing of the process gas flow to be introduced and as a holding device of the exchangeable filter element 18, as a result of which an extremely simple and cost-effective exchange method of the filter element 18 can be made possible. In this respect, it is possible, for example, for an operator for exchanging the above-mentioned filter element 18 to open only the processing chamber P via a pre-mounted door or a movable wall, as shown by way of example in FIG. 1, and to remove a used filter element manually between the perforated plates 14 and 16 or to insert a filter element to be newly used into the latter, such that the filter element 18 can be exchanged quickly and efficiently. In further exemplary embodiments, it can additionally also be possible that other device elements of the filter device FV, such as for example the perforated plates 14 and 16, can also be configured to be exchangeable, such that the filter device FV can preferably also be configured to be modular in its entirety.

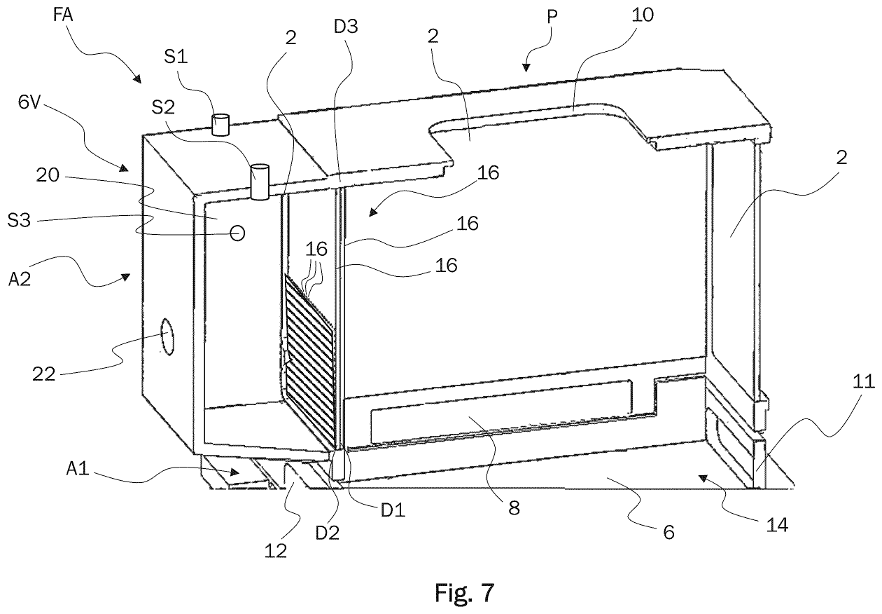

In a further exemplary embodiment, according to FIG. 7, which is based on one or a combination of the above-mentioned exemplary embodiments, a further improvement of the described device and of the manufacturing method is achieved, specifically by an advantageous adaptation of the sensor system for detecting the process parameters and/or the gas properties.

In known systems, the sensor system (in particular the oxygen sensors) is positioned directly in the processing chamber and is thus exposed to the welding fumes, condensate and powder, as a result of which not only the service life of the sensor system is reduced, but also the process control can become more inaccurate over time and the component quality can become poorer.

Therefore, in a development in FIG. 7 of the described device, it is proposed to arrange the sensor system (preferably with one or more of the sensors S1, S2, S3) upstream of the filter element 18 (in relation to the flow direction during the manufacture of a component) and/or upstream (in relation to the flow direction during the manufacture of a component) of the perforated plates 16. The sensor system can therefore preferably be arranged in the fluid chamber 20. Here, the arrangement of at least two sensors S1 and S2 opposite one another and on the upper side of the fluid chamber 20 and of a further sensor S3 on a side wall of the fluid chamber has proven particularly advantageous.

The sensor system is particularly advantageously arranged on the upper side (on the upper cover) of the fluid chamber 20. Alternatively, the sensors can also be arranged on the upper side and on a side surface of the fluid chamber 20. By means of this arrangement, it is therefore possible to detect the supplied gas, which is guided through the fluid chamber 20, through the filter element 18 into the processing chamber P, very precisely in order, for example, to determine the oxygen content and/or moisture content.

In a development, the gas pressure can also be determined by the sensor system arranged on (or in) the fluid chamber 20. As illustrated in FIG. 7, the filter device FV (with at least one perforated plate 16 and the filter element 18) is formed here as part of a wall of the fluid chamber 20 and at the same time as part of a wall of the processing chamber P.

The positioning of the first sensor system (partially or preferably completely) in the fluid chamber 20 (gas inlet box) and thus, as viewed from the processing chamber, behind the filter element (and in particular behind the filter fleece or the membrane) enables an increase in the service life of the sensor system and at the same time an optimised/more precise process control. A second sensor system can optionally additionally be arranged in the processing chamber.

Thus, the sensors are protected from the process by-products, as a result of which a longer service life can be achieved. In addition to the oxygen sensors, further sensors such as, for example, moisture sensors or else pressure sensors (particularly advantageously at least one oxygen partial pressure sensor and/or one nitrogen partial pressure sensor) can also be positioned there. It is thus proposed to use the filter element 18 with a multiple function, specifically for shielding the sensor system (with one or more sensors S1, S2, S3) from contamination from the processing chamber P (construction chamber) and at the same time as an element that prevents the penetration of harmful residual particles upstream into the provided gas feed line (with the possibility of gas feed continuing), wherein the provided distribution element simultaneously ensures a gas flow profile that is as large as possible and thus of high quality. In addition, the first sensor system is also protected from contamination or damage during the unpacking process by this arrangement. Particles occurring during the manufacturing of the component (workpiece) are therefore blocked by the filter medium and particles occurring during the unpacking process are likewise blocked by the filter medium in order to protect the first sensor system.

The advantageously arranged (first) sensor system can comprise one or more pressure sensors. The pressure sensors can be configured to detect the process pressure and/or the filter differential pressure. Further advantageously, the sensor system comprises a sensor for detecting the oxygen content in the processing chamber and/or in the area of the filter. In addition, a sensor can be provided for detecting the gas flow. Furthermore, a temperature sensor can be provided for detecting the gas temperature and/or the dew point of the process gas and/or the construction space temperature. Thus, the first sensor system (preferably with the sensors S1, S2, S3) is arranged behind the filter device, protected from the influence of process by-products from the processing chamber. The gas supplied into the processing chamber P is therefore first guided into the fluid chamber 20 before this gas flows through the filter element 18 into the processing chamber P. In the fluid chamber 20, a detection of process variables and/or gas properties can thus take place by the first sensor system.

Present features, components and specific details can be exchanged and/or combined in order to create further embodiments, depending on the required purpose of use. Any modifications which lie within the area of knowledge of the person skilled in the art are implicitly disclosed with the present description.

### REFERENCE SIGNS LIST

Processing chamber walls 2
material layer 6
working area 4
coating 8
protective glass 10
gas outlet 11
gas inlets 12; 13
distribution element 13
perforated plates 14; 16
filter element 18
flow chamber, fluid chamber 20
connection opening 22
base area A1
portion A2
width D1
thickness D2
filter width D3
manufacturing facility FA
filter device FV
perforations, perforations L1; L2; L4
pore size, pore M
processing chamber P
Sensors S1, S2, S3

1. A filter device for adjusting an atmosphere in a manufacturing facility based on optical interactions, in particular a SLM facility, comprising at least one light source configured for manufacturing a workpiece, a plurality of optical elements for controlling a light path emanating from the light source and a processing chamber defining a working area of the manufacturing facility, comprising:
a distribution element for the planar introduction of a process gas flow into the working area of the manufacturing facility, wherein the distribution element comprises at least one perforated plate and;
at least one filter element for homogenizing the process gas flow;
wherein,
the filter element is arranged on at least one perforated plate of the distribution element; and
the filter device is configured to be integrated at least on a wall of the processing chamber.

2. The filter device according to claim 1, wherein
the filter device comprises at least two perforated plates; and at least one of the perforated plates of the distribution element and/or the filter element are configured to be exchangeable.

3. The filter device according to claim 1, wherein
the filter element comprises a filter medium configured for particle filtration; wherein
the filter medium has a pore with a predefined pore size; and
the pore size of the filter medium is configured such that:
process gas to be guided through the distribution element is let through, and
particles occurring during the manufacturing of the workpiece are blocked by the filter medium and/or particles occurring during the unpacking process are blocked by the filter medium.

4. The filter device according to at least claim 3, wherein
the filter element configured to homogenize and/or filter the process gas flow to be guided through the distribution element by means of adapting at least the thickness and/or the pore size of the used filter medium.

5. The filter device according to claim 1, wherein the filter device comprises at least a first perforated plate and a second perforated plate;
wherein the first perforated plate of the distribution element is configured as an inlet of the process gas into the filter device and the second perforated plate is configured as an outlet of the process gas from the filter device into the processing chamber of the manufacturing facility; and wherein
at least the second perforated plate is configured to be integrated in the wall of the processing chamber.

6. The filter device according to claim 1, wherein
at least two perforated plates of the distribution element are aligned parallel to one another, so that the distribution element forms a rectilinear fluid chamber; and wherein
the filter element fills a cavity of the distribution element provided by the at least two perforated plates.

7. The filter device according to claim 1, wherein
the distribution element comprises an adjustable filter receptacle for the guided positioning of at least one of the perforated plates and/or of the filter element at a working position on the filter device; wherein
the filter receptacle is configured to guide the at least one perforated plate and/or the filter element for positioning at the working position along at least one predefined direction and to fix it at the working position.

8. The filter device according to claim 1, wherein
the at least one perforated plate is configured to vary the flow behavior of the process gas flow by means of adapting at least the thickness and/or the size of the perforations located in the perforated plate.

9. The filter device according to claim 1, wherein
the filter element is formed as an antistatic filter fabric.

10. A manufacturing system for manufacturing a workpiece with a manufacturing facility based on optical interactions, in particular a SLM facility, comprising:
a manufacturing facility based on optical interactions comprising at least one light source configured for manufacturing the workpiece, a plurality of optical elements for controlling a light path emanating from the light source and a processing chamber defining a working area of the manufacturing facility; and
at least one filter device according to claim 1;
wherein
the at least one filter device is configured to be integrated on a wall of the processing chamber.

11. The manufacturing system according to claim 10, wherein
the manufacturing facility based on optical interactions further comprises a gas inlet device for generating and/or introducing a process gas into the working area of the processing chamber; wherein
the gas inlet device is fluidically connected to the filter device; and
the gas inlet device is configured to introduce process gas into the filter device and to introduce the process gas through the at least one perforated plate of the filter device into the working area of the processing chamber.

12. The manufacturing system according to claim 11, wherein
the gas inlet device is configured to adapt the flow property of the process gas flow based on the properties of the distribution element and/or of the filter element.

13. The manufacturing system according to claim 10, wherein
the manufacturing facility based on optical interactions comprises a primary process gas flow guided along the base area of the working area for removing particle residues at the base area and a planar secondary process gas flow for removing particle residues in the processing chamber; and wherein
the process gas flow introduced through the filter device into the working area of the manufacturing facility forms at least the secondary gas flow.

14. A method for adjusting an atmosphere within a manufacturing facility based on optical interactions, in particular a SLM facility, comprising at least one light source configured for manufacturing a workpiece, a plurality of optical elements for controlling a light path emanating from the light source and a processing chamber defining a working area of the manufacturing facility, the method comprising at least one of the steps:
integrating a filter device according to claim 1 on at least one wall of the manufacturing facility;
generating a regulated process gas flow into the working area of the processing chamber by introducing a process gas flow guided through the filter device into the processing chamber;
regulating the process gas flow by adapting the properties of the distribution element and/or of the filter element of the filter device, in particular by exchanging the filter element.

15. The method according to claim 14 further comprising at least one of the steps:
regulating the process gas flow to be introduced into the filter device by means of a gas inlet device depending on the properties of the distribution element and/or of the filter element of the filter device;
exchanging the at least one perforated plate and/or the filter element before a material change of the manufacturing facility, wherein the exchanged perforated plate and/or the filter element is adapted to the exchanged material.
